(19) United States
(12) Patent Application Publication
(10) Pub. No.: US 2026/0329659 A1
(43) Pub. Date: Oct. 22, 2026

(54) ADAPTIVE BEHAVIORAL AUTO SCALING IN A NODE CLUSTER

(71) Applicant: DELL PRODUCTS L.P., Round Rock, TX (US)

(72) Inventors: Govindasamy Chinnu, Bengaluru (IN); Sharath Kumar, Bengaluru (IN); Rishi Mukherjee, Bangalore (IN)

(21) Appl. No.: 19/182,864

(22) Filed: Apr. 18, 2025

(51) Int. Cl. G06F 9/50

(52) U.S. Cl. CPC G06F 9/505

(57) ABSTRACT

An adaptive behavioral scaling node of a cluster includes a storage device and a processor. The storage device store multiple machine learning models. The adaptive behavioral scaling node executes the machine learning models. Based on the execution of the machine learning models, adaptive behavioral scaling node predicts workload demands within the cluster. One machine learning model predicts a first portion of the workload demands based on historical data for the cluster. Another machine learning predicts a second portion of the workload demands based on user behavior patterns. In response to the prediction of the workload demands, adaptive behavioral scaling node dynamically adjusts resources among different nodes of the cluster.

### FIELD OF THE DISCLOSURE

The present disclosure generally relates to information handling systems, and more particularly relates to adaptive behavioral auto scaling in a node cluster.

### BACKGROUND

As the value and use of information continues to increase, individuals and businesses seek additional ways to process and store information. One option is an information handling system. An information handling system generally processes, compiles, stores, or communicates information or data for business, personal, or other purposes. Technology and information handling needs and requirements can vary between different applications. Thus, information handling systems can also vary regarding what information is handled, how the information is handled, how much information is processed, stored, or communicated, and how quickly and efficiently the information can be processed, stored, or communicated. The variations in information handling systems allow information handling systems to be general or configured for a specific user or specific use such as financial transaction processing, airline reservations, enterprise data storage, or global communications. In addition, information handling systems can include a variety of hardware and software resources that can be configured to process, store, and communicate information and can include one or more computer systems, graphics interface systems, data storage systems, networking systems, and mobile communication systems. Information handling systems can also implement various virtualized architectures. Data and voice communications among information handling systems may be via networks that are wired, wireless, or some combination.

### SUMMARY

An adaptive behavioral scaling node of a cluster includes a storage device and a processor. The storage device store multiple machine learning models. The adaptive behavioral scaling node may execute the machine learning models. Based on the execution of the machine learning models, adaptive behavioral scaling node may predict workload demands within the cluster. One machine learning model may predict a first portion of the workload demands based on historical data for the cluster. Another machine learning model may predict a second portion of the workload demands based on user behavior patterns. In response to the prediction of the workload demands, adaptive behavioral scaling node may dynamically adjust resources among different nodes of the cluster.

### BRIEF DESCRIPTION OF THE DRAWINGS

It will be appreciated that for simplicity and clarity of illustration, elements illustrated in the Figures are not necessarily drawn to scale. For example, the dimensions of some elements may be exaggerated relative to other elements. Embodiments incorporating teachings of the present disclosure are shown and described with respect to the drawings herein, in which:

FIG. 1 is a block diagram of a multiple node environment according to at least one embodiment of the present disclosure;

FIG. 2 is a diagram of an adaptive behavioral scaling node of the multiple node environment according to at least one embodiment of the present disclosure;

FIG. 3 is a sequence diagram of a method for providing adaptive behavioral autoscaling in a multiple node environment according to at least one embodiment of the present disclosure;

FIG. 4 is a flow diagram of a method for providing adaptive behavioral autoscaling in a multiple node environment according to at least one embodiment of the present disclosure; and

FIG. 5 is a block diagram of a general information handling system according to an embodiment of the present disclosure.

The use of the same reference symbols in different drawings indicates similar or identical items.

### DETAILED DESCRIPTION OF THE DRAWINGS

The following description in combination with the Figures is provided to assist in understanding the teachings disclosed herein. The description is focused on specific implementations and embodiments of the teachings and is provided to assist in describing the teachings. This focus should not be interpreted as a limitation on the scope or applicability of the teachings.

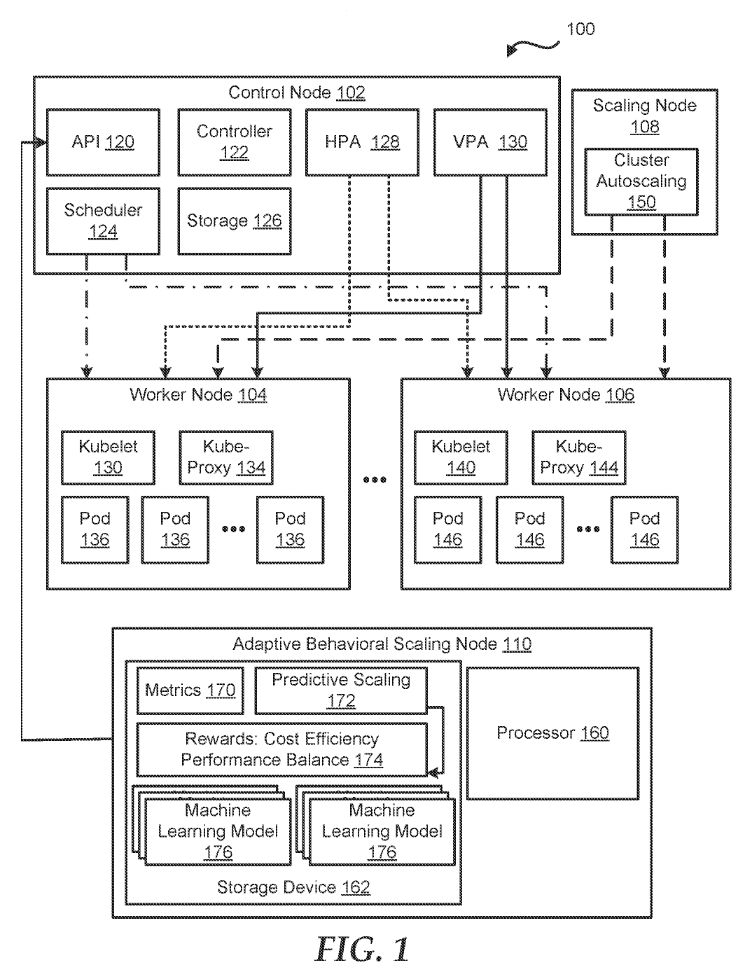

FIG. 1 illustrates a node cluster system 100 including a control node 102 and worker nodes 104 and 106 according to at least one embodiment of the present disclosure. In certain examples, control node 102 and worker nodes 104 and 106 may be any suitable information handling system. For purposes of this disclosure, an information handling system can include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (such as a desktop or laptop), tablet computer, mobile device (such as a personal digital assistant (PDA) or smart phone), server (such as a blade server or rack server), a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components.

FIG. 1 illustrates a multiple node environment 100 according to at least one embodiment of the present disclosure. Multiple node environment 100 includes control node 102, worker nodes 104 and 106, a scaling node 108, and an adaptive behavioral scaling node 110. Control node 102 includes an application program interface (API) 120, a controller 122, a scheduler 124, a storage 126, a horizontal pod autoscaler (HPA) 128, and a vertical pod autoscaler (VPA) 130. In an example, controller 122 may be any suitable processor or controller, such as a life cycle controller (LCC). Control node 102 may include LCC 122 while in a bare metal state. Storage 126 may store any suitable data associated with nodes 104 and 106, such as an update bundle 128. Worker node 104 includes a kubelet 130, a Kube-proxy 134, and multiple pods 136. Worker node 106 includes a kubelet 140, a Kube-proxy 144, and multiple pods 146. Scaling node 108 includes a cluster autoscaling component 150. Adaptive behavioral scaling node 110 includes a processor 160 and a storage device 162. Storage device 162 may store any suitable data associated with multiple node environment 100 including, but not limited to, state metrics 170, predictive scaling 172, rewards data 174, and multiple machine learning models 176. In an example, multiple node environment 100 may be any suitable environment including but not limited to a Kubernetes cluster. Multiple environment 100 may be a cloud system with one or more bare metal servers, such as worker nodes 104 and 106.

In certain examples, multiple node environment 100 may include any suitable number of worker nodes as illustrated by the ellipses between worker nodes 104 and 106. For example, the Kubernetes cluster of multiple node environment 100 may operation on worker nodes 104 and 106, on three worker nodes, on five worker nodes, or the like. In certain examples, HPA 128 and VPA 130 may be implemented across multiple servers, such as worker nodes 104 and 106. In an example, operations and features of the components in worker nodes 104 and 106, such as kubelets 130 and 140, Kube-proxies 134 and 144, and pods 136 and 146, are known in art and will not be further disclosed herein, except as needed to illustrate the various embodiments disclosed herein. Similarly, operations and features of the components in scaling node 108, such as cluster autoscaling 150, are known in art and will not be further disclosed herein, except as needed to illustrate the various embodiments disclosed herein. Control node 102, and worker nodes 104 and 106 may include additional or fewer components without varying from the scope of this disclosure.

In addition, connections between components may be omitted for descriptive clarity. In certain examples, clusters, such as multiple node environment 100, may be flat, hierarchical/distributed, or the like. Flat clusters may include all hosts/nodes on a common structure, such as a switch. Hierarchical or distributed clusters may include hosts/nodes in different geographical locations, different switches/sub nets, different racks, or the like. In an example, the cluster may include any number of control nodes 102, and these control nodes may also be worker nodes. In this example, movement of applications, such as via Kubernetes services, between nodes to keep the control functionality working as control node(s) 102 are updated. In certain examples, at least one control node 102 may be replicated to enable the control nodes to continue to work during upgrades.

In certain examples, pods 136 and 146 may be the smallest deployable units of computing that may be created and managed in Kubernetes clusters. Pods 136 may be a group of one or more containers within worker node 104, with shared storage and network resources, and a specification for how to run the containers. Similarly, pods 146 may be a group of one or more containers within worker node 106, with shared storage and network resources, and a specification for how to run the containers. In an example, the contents of pods 136 and 146 may be co-located, co-scheduled and run in a shared context. In certain examples, worker nodes 104 and 106 may be bare metal information handling systems with one or more pods 136 and 146. In an example, pods 136 and 146 may be application-specific logical host that contain one or more application containers which are relatively tightly coupled. In non-cloud contexts, applications executed on the same physical or virtual machine may be analogous to cloud applications executed on the same logical host. In an example, pods 136 and 146 may include initialization containers that run during startup of the pods.

In Kubernetes clusters, such as multiple node environment 100, cluster autoscaling 150 of scaling node 108 primarily depends on central processing unit (CPU) and memory metrics to scale-up or scale-down operations. However, modern cloud-native applications create complex workloads affected by dynamic factors beyond CPU and memory. In these situations, scaling node 108 may not take in account factors such as network bandwidth, disk I/O, database transactions, and real-time application-level performance metric. However, these factors may play a crucial role in deciding optimal resource allocation. In an example, adaptive behavioural scaling node 110 may utilize these metrics to improve resource scaling between nodes 104 and 106 within multiple node environment 100.

In an example, each of HPA 128 and VPA 130 may fail to consider aspects, such as real-time application-level performance metrics. Scaling node 108, HPA 128, and VPA 130 may perform inefficient scaling decisions. In certain examples, the limitations of scaling node 108, HPA 128, and VPA 130 may be particularly evident in microservices-based architectures, where services have unpredictable resource demands based on interdependences. In these situations, Kubernetes clusters, such as multiple node environment 100, may struggle to provide a continuous and cost-effective scaling solution that aligns with application needs.

Another significant challenge in Kubernetes autoscaling 150 may be the delayed reaction to workload fluctuations. HPA 128 and VPA 130 may function on periodic polling, which in turn may introduce lag in scaling decisions. By the time autoscaling 150 of scaling node 108 detects abnormal resource utilization and enabling the scaling, the corresponding application may have already reached the degraded performance or downtime. The delayed response is critical for applications and requiring real-time adaptability, such as financial transaction systems, video streaming services, and high-frequency trading platforms. In an example, the inability of scaling node 108, HPA 128, and VPA 130 to proactively scale resources based on real-time trends leads to inefficiencies in handling workload variations and causes performance bottlenecks and financial losses.

Additionally, over-provisioning nodes 104 and 106 may result in unnecessary expenses in multiple node environment 100, while under-provisioning the nodes may lead to performance degradation. In an example, autoscaling policies scaling node 108 may not account for cost-aware scaling strategies that dynamically balance resource allocation against operational costs. In certain examples, cloud-based Kubernetes clusters, such as multiple node environment 100, may cause significant financial burdens when scaling inefficiencies result in excessive cloud spending. The absence of intelligent scaling solutions that factor in cost-performance trade-offs may cause Kubernetes autoscaling 150 of scaling node 108 to suboptimal for large-scale deployments.

In an example, adaptive behavioural scaling node 110 improve the auto-scaling of resources among the nodes, such as nodes 104 and 106, in multiple node environment 100 may apply machine learning (ML)-based adaptive autoscaling to provide a more dynamic and intelligent approach to Kubernetes scaling. Adaptive behavioural scaling node 110 may further improve the operation of nodes 104 and 106 by not relying on static CPU/memory thresholds but instead utilizing ML models 176 may provide autoscaling to analyse multiple real-time parameters, including network I/O, disk usage, and user request rates, to make scaling decisions. These operations by adaptive behavioural scaling node 110 may prevent service degradation and ensure optimal performance even during unpredictable traffic spikes. Additionally, deep learning and reinforcement learning (RL) models 176 may allow the autoscaling to continuously learn and improve scaling strategies. By analysing past scaling events and their impact on application performance, RL models 176 may adjust scaling policies dynamically. The utilization of ML models 176 by adaptive behavioural scaling node 110 may eliminate inefficiencies caused by static rule-based scaling and adapts to real-world workload variations.

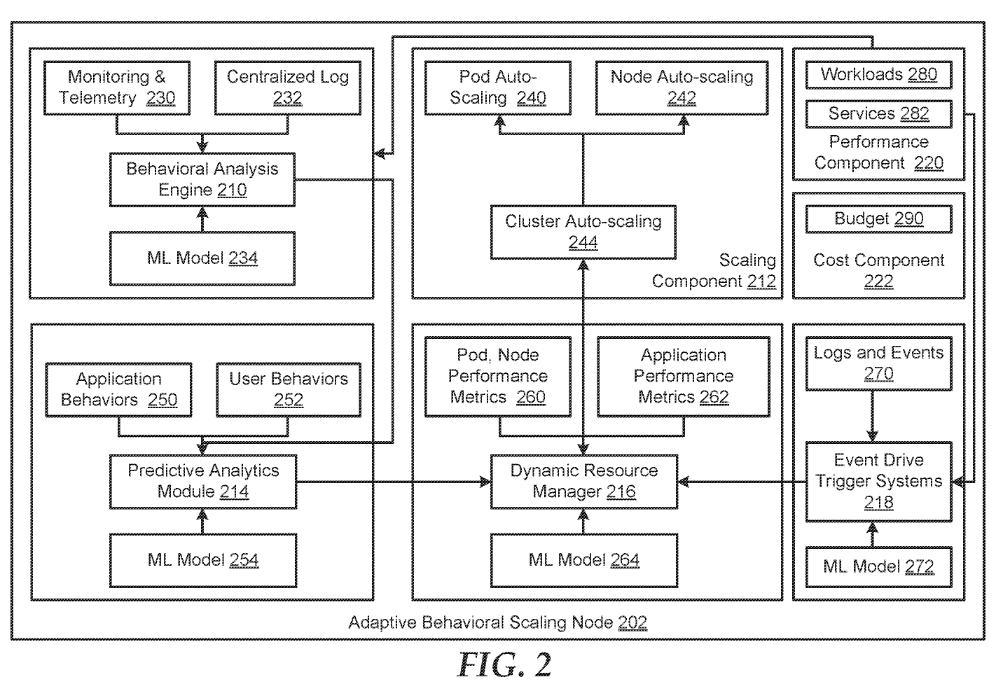

Adaptive behavioral scaling node 110 may leverage ML models 176 to predict and adapt to workload demands based on real-time user behavior, historical data, and external event triggers. For example, adaptive behavioral scaling node 110 may continuously analyze user interaction patterns, service usage metrics, and external events to dynamically adjust resource allocation within the Kubernetes cluster of multiple node environment 100. Additional, operations of adaptive behavioral scaling node 110 will be described with respect to FIG. 2 below.

FIG. 2 illustrates an adaptive behavioral scaling node 202 with respect to at least one embodiment of the present disclosure. In an example, adaptive behavioral scaling node 202 may be substantially similar to adaptive behavioral scaling node 110 of FIG. 1. Adaptive behavioral scaling node 202 includes a behavioral analysis engine (BAE) component 210, a scaling component 212, a predictive analytics module (PAM) component 214, a dynamic resource manager (DRM) component 216, an event driven trigger system (EDTS) component 218, a performance component 220, and a cost component 222. In an example, BAE component 210, scaling component 212, PAM component 214, DRM component 216, EDTS component 218, performance component 220, and cost component 222 may be executed by a processor, such as processor 160 of FIG. 1. Adaptive behavioral scaling node 202 may include additional components without varying from the scope of this disclosure.

BAE component 210 includes monitoring and telemetry data 230, and a centralized log 232, and a ML model 234. Scaling component 212 includes pod autoscaling 240, node autoscaling 242, and cluster autoscaling 244. PAM component 214 includes application behaviors data 250, user behaviors data 252, and ML models 254. DRM component 216 includes pod and node performance metrics data 260, application performance metrics data 262, and ML models 264. EDTS component 218 includes logs and events data 270 and ML model 272. Performance component 220 includes workload data 280 and services data 282. Cost component 222 includes budget 290. ML models 234, 254, 264, and 272 may be substantially similar to ML models 176 of FIG. 1 and may be stored in a storage device, such as storage device 162 of FIG. 1.

In an example, BAE component 210 may continuously collect and analyze user behavior patterns and service usage data. In certain examples, ML model 234 of BAE component 210 may be any suitable type of ML model, such as a deep learning model. Additionally, ML model 234 may include a long short-term memory autoencoder (LTSM) at the learning phase. In certain examples, ML model 134, via LTSM, may include an exceptional capability to learn temporal dependencies inherent in sequential data. This capability may enable ML model 234 analyse dynamic behavioural patterns. In an example, the LSTM may enable ML model 234 to remember long-term dependencies, while the autoencoder structure may provide a mechanism to measure reconstruction errors that signal anomalies. ML model 234 may support unsupervised learning, which in turn may reduce the reliance of BAE component 210 on vast amounts of labelled data. In an example, BAE component 210 may benefit from container orchestration and scalability, ensuring robust deployment even as data streams continuously evolve. The operation of ML model 234 in BAE component 210 may both enhance predictive accuracy and facilitate real-time anomaly detection.

In certain examples, BAE component 210 may receive both structured data and unstructured data. In an example, the structured data may include, but is not limited to, system logs, transaction records, and event timestamps that may be stored as telemetry data 230 and within centralized log 232. Additionally, BAE component may utilize unstructured data, such as textual logs and sensor readings. In an example, data sources 230 and 232 may include application logs from microservices, network telemetry, and container runtime statistics, which together may provide a comprehensive picture of system behaviour.

Training ML model 234 of BAE component 210 involves a systematic, multi-phase process that starts with thorough data preprocessing. Initially, raw data is cleansed, normalized, and segmented into time-series sequences, creating a high-quality input for the LSTM autoencoder of ML model 234. In an example, historical behavioural data may be used to teach ML model 234 the data that constitutes normal activity, which in turn may enable the ML model to later recognize deviations. During training of ML model 234, techniques such as early stopping, cross-validation, and hyperparameter tuning may be applied to prevent overfitting and to optimize the network architecture. The training pipeline is containerized and executed within the Kubernetes multiple node environment 100 of FIG. 1. In an example, multiple node environment 100 of FIG. 1 may provide scalability and efficient resource allocation, particularly when leveraging GPU acceleration for faster computation.

In an example, when ML model 234 of BAE component 210 detects anomalies, the anomalies are logged and reviewed. In certain examples, the review of the anomalies may be performed either by automated metrics or via human-in-the-loop verification. The review of the anomalies may involve a determination of whether the anomalies represent true deviations from past behaviours or false positives. After the review of the detected anomalies is completed, the review data is provided as feedback data to fine-tune thresholds for ML model 234 and periodically retrain the LSTM autoencoder. In an example, retraining and fine-tuning of ML model 234 may ensure that BAE component 210 may adapt to emerging behavioural trends.

In certain examples, the fine-tuning of ML model 234 may enable incremental updates to model weights without requiring a complete retraining cycle of the ML model. These incremental updates reduce downtime of adaptive behavioural scaling node 202 and maintain operational accuracy of ML model 234 in BAE component 210. Kubernetes plays a vital role in this self-learning environment by facilitating rolling updates and seamless model redeployment. Over time, BAE component 210 may improve its detection accuracy, reduce the incidence of false alarms while staying sensitive to genuine anomalies, or the like. In an example, the continuous improvement process of ML model 234 in BAE component 210 may enhance predictive performance and strengthen overall system resilience in dynamic and unpredictable environments.

After ML model 234 has been trained and multiple node environment 100 of FIG. 1 is in operation, a user may interact with an application in a multiple node environment. During the execution of the application and the interaction with the user, BAE component 210 may receive user behavior and usage data 230. This user behavior data and usage data may be input into ML model 234. In an example, ML model 234 may perform one or more operations to analyze the user behavior and usage data. In response to the data being analyzed by ML model 234, the result of the analysis is provided at an output layer of the ML model. The user behavior data may be any suitable data associated with how and when users access or interact with application. In an example, the usage data may be at suitable structured or unstructured data from the nodes of the cluster, from applications running on the nodes, or the like.

In an example, workload data 280 and services data 282 of performance component 220 may be provided to BAE component 210. Workload data 280 and services data 282 may be utilized by ML model 234 or other portions of BAE component 210 during the analysis of the user behavior data and the usage data. In response to ML model 234 completing the analysis of the data, BAE component 210 may send or provide the analyzed data to PAM component 214.

In certain examples, PAM component 214 may utilize ML model 254 to predict workload changes based on historical data and external factors. ML model 254 may employ a supervised learning algorithm. In an example, ML model 254 may be an eXtreme Gradient Boosting (XGBoost) algorithm for its core predictive model capabilities. The XGBoost algorithm may enable ML model 254 to provide robustness, efficiency, and exceptional accuracy when handling structured data. The capabilities of the XGBoost algorithm are known in the art and will not be further disclosed herein, except as needed to illustrate the various embodiments of the present disclosure. In certain examples, the utilization of the XGBoost algorithm in ML model 254 enables PAM component 214 to process large volumes of historical and real-time data efficiently. Thus, ensuring fast inference and scalability in a Kubernetes environment, such as multiple node environment 100 of FIG. 1. ML model 254 may utilize the analyzed data from BAE 210 to deliver timely and actionable insights to support decision-making processes.

In certain examples, PAM component 214 may rely on a comprehensive dataset that includes both historical and real-time data streams. The primary data sources may be structured data from databases, transactional logs, and time-series data representing system metrics, and user behaviours 252. In an example, input data for ML model 254 may be high-quality, cleaned, and normalized data to ensure consistency and accuracy in the predictions output from the ML model. In certain examples, PAM component 214 may perform preprocessing steps. These steps may involve feature extraction, handling missing values, and data normalization to create a robust input matrix suitable for ML model 254. In an example, data may be ingested by ML model 254 via real-time APIs or batch processing pipelines within the Kubernetes cluster of multiple node environment 100 of FIG. 1. ensuring that the model is constantly updated with the latest information. Based on the execution of ML model 254, PAM component 214 may identify trends, detect anomalies, and forecast outcomes with a high degree of precision, which is vital for proactive decision-making and strategic planning in complex operational environments.

In an example, training ML model 254 in PAM component 214 may be a systematic process that begins with extensive data preparation. In certain examples, ML model 254 may be trained using prepared datasets to leverage cross-validation and hyperparameter tuning to optimize its performance. Distributed training frameworks within Kubernetes allow for parallel processing and efficient resource management, ensuring that even large-scale datasets may be processed without significant delays. During training, ML model 254 may learn to recognize underlying patterns and relationships within the analysed data, which in turn may establish a robust baseline for future predictions. In certain examples, the training process ML model 254 may also incorporate techniques, such as early stopping and regularization, to prevent overfitting, ensuring that the model generalizes well to new, unseen data. After ML model 254 is trained, the ML model may be exported as a deployable artifact, ready for integration into real-time predictive workflows that drive business insights and automated decision-making.

PAM component 214 may include a self-learning capability, which ensures that ML model 254 remains accurate and relevant over time. In an example, ML module 254 incorporates an automated feedback loop that continuously collects data on prediction outcomes and model performance. This feedback may be analysed to detect discrepancies between predicted and actual results, triggering scheduled or on-demand retraining cycles.

During execution of ML model 254, PAM component 214 may predict a future workload for a cluster, such as multiple node environment 100 of FIG. 1. In an example, the future workload may be for one particular node or multiple nodes of the multiple node workload. The predicted workload may be based on the analyzed data received from BAE component 210. In response to ML model 254 outputting a predicted workload, PAM component 214 may provide the predicted workload to DRM component 216.

In an example, EDTS 218 may integrate with external APIs to detect and respond to events that could impact a service demand within a cluster, such as multiple node environment 100 of FIG. 1. In certain examples, ML model 272 may utilize a deep neural network algorithm which is temporal convolutional network (TCN) as its core learning model. The capabilities of the TCN are known in the art and will not be further disclosed herein, except as needed to illustrate the various embodiments of the present disclosure. In an example, ML model 272 may capture long-range dependencies efficiently while being parallelizable. ML model 272 may process large volumes of event data, where quick detection of patterns or anomalies is necessary to trigger subsequent actions. Furthermore, ML model 272 may include the ability to handle variable sequence lengths and provide stable gradients during training. In an example, ML model 272 may learn complex temporal patterns from streaming event data and make accurate predictions on trigger conditions. This approach ensures that the system remains agile and responsive, adapting seamlessly to varying workloads and operational scenarios.

In certain examples, EDTS 218 may rely on a diverse range of data inputs that capture both historical and real-time event dynamics. This data may include structured event logs 270, sensor outputs, API call records, and system telemetry. These data sources may provide a comprehensive view of the operational environment by recording occurrences such as user actions, system errors, and environmental sensor readings. In certain examples, EDTS 218 may construct time-series windows to capture sequential relationships across events, which may be utilized by ML model 272 to recognize patterns and predict trigger conditions accurately. Data ingestion at ML model 272 may be in any suitable manner such as via streaming pipelines integrated with log management systems and cloud telemetry services. In an example, the combination of historical datasets with live event streams may enable EDTS 218 to learn from past patterns and adapt quickly to new trends. These operations by EDTS 218 may enable adaptive behavioral scaling node 202 responsive and reliable in dynamic operational settings.

During training of ML model 272, EDTS 218 may implement a multi-phase process that starts with assembling a robust dataset derived from historical event logs 270 and simulated real-time streams. In the initial phase, data may be segmented into fixed-length sequences and enriched with relevant features such as timestamps, event categories, and metadata. ML model 272 then may be trained using these preprocessed sequences, such that dilated convolutions learn to capture long-term dependencies across the event timeline. During training, techniques such as batch normalization, dropout, and early stopping may be applied to prevent overfitting and enhance generalization.

In certain examples, EDTS 218 may include a self-learning capability for ML model 272. This self-learning capability may enable continuous improvement to ML model 272 over time. For example, EDTS 218 may be designed with an automated feedback loop that constantly monitors the accuracy of the trigger predictions from ML model 272 and the outcomes of triggered events. When discrepancies or false positives are detected, EDTS 218 logs these instances 270 and uses the logs as feedback to fine-tune the parameters of ML model 272. Incremental learning techniques allow EDTS 218 to update ML model 272 weights on-the-fly, without requiring complete retraining from scratch. Over time, these self-learning capabilities may lead to more precise trigger activations, reduced false alarms, and a continuously optimized event detection system within ML model 272 that can reliably support dynamic and mission-critical operations.

In an example, EDTS 218 may provide external data and trigger activations from ML model 272 DRM 216. In an example, the external data may be any suitable data not generated by nodes within the multiple node environment. For example, the external data may be any event data that may impact a service demand for the nodes of the multiple node environment. In certain examples, the external event data may include, but is not limited to, network traffic data, weather data, and social media data. In an example, EDTS 218 may provide the external data and trigger activations to DRM through PAM component 214. For example, PAM component 214 may adjust the workload predications provided to DRM component 216 based on the received external event data.

In certain examples, DRM component 212 may interface with a Kubernetes API via scaling component 212 to adjust pod and node resources dynamically based on predictions made by PAM component 214 and the data from EDTS 218. In an example, DRM component 212 may dynamically allocate computing resources based on workload fluctuations. DRM component 212 may leverage ML model 264, and ML model may be any suitable ML model. For example, ML model 264 may utilize reinforcement learning (RL) with a proximal policy optimization (PPO) algorithm. The capabilities of the RL with the PPO algorithm are known in the art and will not be further disclosed herein, except as needed to illustrate the various embodiments of the present disclosure.

In an example, DRM 216 may observe metrics 260 and 262 to determine the best scaling actions. These metrics 260 and 262 may include, but are not limited to, CPU load, memory utilization, and network throughput. Based on utilization of PPO, ML model 264 of DRM component 216 may learn effective policies that balance cost efficiency from cost component 222 with workloads 280 and services 282 in performance component 220. These policies may contribute to the balancing by DRM component 216 continuously interacting with multiple node environment 100 of FIG. 1 and updating the policies accordingly. ML model 264 may enable DRM component 216 to both accommodate sudden workload changes and adapt to long-term trends. This capability of DRM component 216 may improve resource scaling in platforms like Kubernetes where resource demands are dynamic and often occur in non-linear circumstances.

In certain examples, DRM component 264 may receive datasets that capture both historical and real-time performance metrics from the multiple node environment 100 of FIG. 1. This data may be metric data 260 and 262 that may include, but is not limited to, CPU usage, memory consumption, network I/O, and application-level performance indicators. In an example, metrics data 260 and 262 may be collected from a cloud infrastructure or on-premises servers. In certain examples, these metrics may gathered through monitoring tools and telemetry systems integrated with Kubernetes clusters, such as nodes 104 and 106 of multiple node environment 100 in FIG. 1. Additionally, DRM component 216 and ML model 264 may utilize system logs, container statistics, and external workload patterns to better determine operational trends.

In an example, DRM component 216 may perform one or more data preprocessing steps before the received data, such as workload predictions from PAM component 214, are provided to ML model 264. The preprocessing steps may involve any suitable steps including, but not limited to, normalization, smoothing of noise, and the creation of time-series windows. In an example, the multi-source data aggregation may ensure DRM component 216 has a comprehensive view of resource utilization patterns. Adaptive behavioral scaling node 202 may integrate both short-term fluctuations and long-term trends to enable DRM component 216 to may informed decisions on resource allocations. In certain examples, the quality and granularity of data from diverse sources may enable DRM component 216 to effectively train ML model 264 to anticipate future load and adapt resource allocations to dynamically to maintain optimal performance.

During the training of ML model 264, DRM component 216 may simulate the operational environment where resource metrics are used to define the state, and actions correspond to scaling decisions. Initially, ML model 264 may be developed to mirror the resource dynamics of a Kubernetes cluster, such as multiple node environment 100 of FIG. 1. In an example, historical performance data may be used to model typical workload patterns and edge-case scenarios. During the training of ML model 264, the PPO algorithm may iteratively interact with this Kubernetes cluster, such as multiple node environment 100 of FIG. 1. In an example, ML model 264 may improve based on resource efficiency and system performance.

During training of ML model 264, DRM component 216 may utilize hyperparameter tuning, early stopping, and periodic validation to refine policies of the ML model. In certain examples, containerized training within Kubernetes clusters may ensure scalability and allow ML model 164 to process large-scale simulation data efficiently. The training process of ML model 264 may be designed to encourage policies that react to immediate system demands and anticipate future workload spikes. This training of ML model 264 may enable DRM component 216 to determine scaling data for resource allocation within multiple node environment 100 of FIG. 1.

In an example, DRM 216 may include a self-learning capability for ML model 264, which allows DRM component to continuously refine the corresponding decision-making policies. In certain examples, adaptive behavioral scaling node 202 may incorporate an automated feedback loop where real-time performance data and scaling outcomes are provided back into the training process. This enables ML model 264 to detect changes in workload patterns and adjust policies accordingly.

In an example, DRM component 216 may provide autoscaling data to scaling component 212, which in turn may provide the scaling data to a Kubernetes API, such as API 120 in control node 102 of multiple node environment 100 in FIG. 1. In certain examples, scaling component 212 may use the scaling data from DRM component 216 as over cluster autoscaling data 244 and may provide the cluster autoscaling data to the Kubernetes API. Based on cluster autoscaling data 244, the control node may reallocate resources between the nodes of a multiple node environment, such as nodes 104 and 106 of multiple node environment 100 of FIG. 1.

In certain examples, scaling component 212 may split the autoscaling data into pod autoscaling data 240 and node autoscaling data 242. Scaling component 212 may provide the separate pod autoscaling data 240 and node autoscaling data 242 to the Kubernetes API. Based on pod autoscaling data 240 and node autoscaling data 242, the control node may reallocate resources between the pods of a single node or between different nodes of a multiple node environment, such as pods 136 of node 104 and pods 146 of node 106 in multiple node environment 100 of FIG. 1. In an example, the resources available to the different nodes of a cluster may include, but are not limited to, network bandwidth, access to shared CPU cores and shared memory. In certain examples, the resources allocation adjusted between pods in a node may include, but are not limited to, CPU cores, memory, and storage. In an example, the reallocation or adjustment of resource between pods may enable better performance of applications assigned to different pods for execution.

As described herein, ML models 234, 254, 264, and 274 may be any suitable ML models. For example, ML model 234 of BAE component 210 may include a LTSM autoencoder. ML model 254 of PAM component 214 may utilize a XGBoost algorithm. ML model 264 of DRM component 216 may be a RL model with a PPO algorithm. ML model 272 of EDTS 218 may be a TCN core learning model. In an example, adaptive behavioral scaling node 202 may integrate the combination of these ML models 234, 254, 264, and 274 to provide a more optimum solution compared to the previous cluster scaling solutions and saving more costs. Based on the operations of ML models 234, 254, 264, and 274, adaptive behavioral autoscaling node 202 may integrate user behavior, predictive analytics, and external event data into a cohesive and adaptive system.

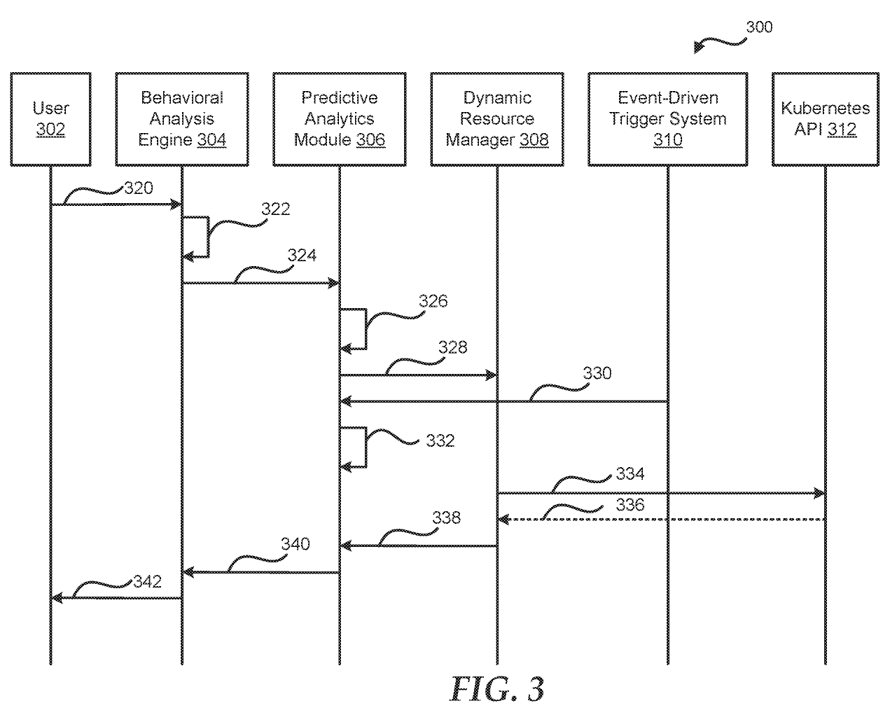

FIG. 3 shows sequence of a method 300 for providing adaptive behavioral autoscaling in a multiple node environment according to at least one embodiment of the present disclosure. Not every method step set forth in this flow diagram is always necessary, and certain steps of the methods may be combined, performed simultaneously, in a different order, or perhaps omitted, without varying from the scope of the disclosure. FIG. 3 may be employed in whole, or in part, a user console 302, a behavioral analysis engine (BAE) component 304, a predictive analytics module (PAM) component 306, a dynamic resource manager (DRM) component 308, an event-driven trigger system (EDTS) component 310, a Kubernetes API 312, or any other type of controller, device, module, processor, or any combination thereof, operable to employ all, or portions of, the method of FIG. 3.

During operation 320, user console 302 interacts with an application in a multiple node environment. In an example, user console 302 may interact with the application in any suitable manner. For example, user console 302 may provide data to the node or nodes executing the application, which in turn may perform one or more operations on the data and return results to the user console.

During operation 322, BAE component 304 analyzing user behavior and usage data. The user behavior data may be any suitable data associated with how and when users access or interact with application. For example, the user behavior data may indicate that a user or users typically interact with the cluster at one or more time windows, on certain days of the week, or the like. In an example, the usage data may be at suitable structured or unstructured data from the nodes of the cluster, from applications running on the nodes, or the like. In certain examples, the structured data may include, but is not limited to, system logs, transaction records, and event timestamps. The unstructured data may be textual logs, sensor readings, or the like. In an example, the data sources may be application logs from microservices, network telemetry, container runtime statistics, or the like. The analysis of the structured and unstructured data may provide a comprehensive overview of system behaviour.

During operation 324, BAE component 304 sends or provides the analyzed data to PAM component 306. During operation 326, PAM component 306 predict a future workload. In an example, the future workload may be for one particular node or multiple nodes of the multiple node workload. The predicted workload may be based on the analyzed data received from the BAE component 304. During operation 328, PAM component 306 sends the predicted workload to DRM component 308.

During operation 330, EDTS 310 provides external data to PAM component 306. In an example, the external data may be any suitable data not generated by nodes within the multiple node environment. For example, the external data may be any event data that may impact a service demand for the nodes of the multiple node environment. In certain examples, the external event data may include, but is not limited to, network traffic data, weather data, and social media data.

During operation 332, PAM component 306 adjusts workload predications based on the received external event data. In an example, the workload predictions may be adjusted for one particular node or multiple nodes of the multiple node workload. The adjustments to predicted workload may be based on the external data received from EDTS 310.

During operation 334, DRM component 308 provides autoscaling data to Kubernetes API 312. In certain examples, the autoscaling data or control signal may be based on the predicted future workload received from PAM component 306. In an example, the autoscaling data may cause Kubernetes API 312 to dynamically adjust pod and node resources. For example, based on the autoscaling data or control signal from DRM component 308, Kubernetes API 312 may adjust resources allocated to the different nodes and different pods within these nodes. In an example, the resources available to the different nodes of a cluster may include, but are not limited to, network bandwidth, access to shared CPU cores and a shared memory. In certain examples, the resources allocation adjusted between pods in a node may include, but are not limited to, CPU cores, memory, and storage. In an example, the reallocation or adjustment of resource between pods may enable better performance of applications assigned to different pods for execution.

During operation 336, Kubernetes API 312 provides resource scaling feedback data to DRM component 308. In an example, the resource scaling feedback data may identifying the impact the resource scaling had on the nodes and pods within the cluster. The resource scaling feedback data may also identify how resources within the cluster are currently allocated between the nodes and the pods of the cluster.

During operation 338, DRM component 308 updates the resource allocation status in PAM component 306. In an example, the resource allocation status update may be generated by DRM component 308 based on the resource scaling feedback data. This resource allocation status update may be stored in a memory of PAM component 306.

During operation 340, PAM component 306 provides the feedback data to BAE component 304. In an example, the feedback provided to BAE component 304 may include the resource status update. During operation 342, the optimized or auto scaled resource allocation results in improved performance at user console 302. In an example, the improvement at user console 302 may include, but is not limited to, quicker results from applications and more accurate data.

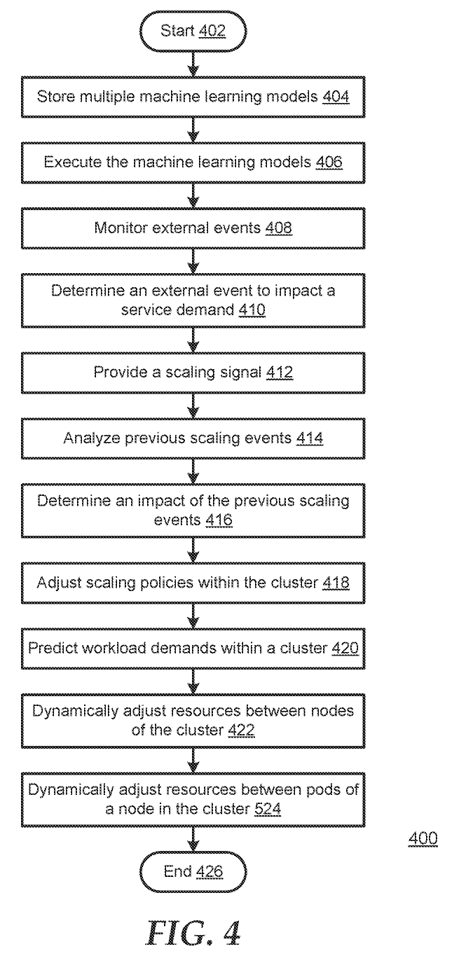

FIG. 4 shows a method 400 for adaptively auto scaling in a node cluster according to at least one embodiment of the present disclosure, starting at block 402. Not every method step set forth in this flow diagram is always necessary, and certain steps of the methods may be combined, performed simultaneously, in a different order, or perhaps omitted, without varying from the scope of the disclosure. FIG. 4 may be employed in whole, or in part, a user console 302, a behavioral analysis engine (BAE) component 304, a predictive analytics module (PAM) component 306, a dynamic resource manager (DRM) component 308, an event-driven trigger system (EDTS) component 310, a Kubernetes API 312, or any other type of controller, device, module, processor, or any combination thereof, operable to employ all, or portions of, the method of FIG. 4.

At block 404, multiple machine learning models are stored. In an example, the machine learning models may be stored in any suitable location within a multiple node environment, such as in a storage device of an adaptive behavioral scaling node in a cluster of the multiple node environment. At block 406, the machine learning models are executed. In certain examples, the different machine learning models may analyze different parameters, usage, and events within the cluster of nodes.

At block 408, external events are monitored. In an example, the external events may be monitored by any suitable device or component within an adaptive behavioral scaling node, such as an event-driven trigger system. In certain examples, the external event may be any suitable events that occur outside or beyond the cluster. For example, the external events may include, but are not limited to, social media trends, weather, and stock market changes. In an example, the event-driven trigger system may communicate with APIs that are external to the cluster to monitor the external events. In certain examples, time-series windows may be utilized to capture sequential relationships across different external events. These sequential relationship may be essential to recognize patterns and predict trigger conditions accurately. In an example, data ingestion may be handled via streaming pipelines integrated with log management systems and cloud telemetry services. The combination of historical datasets with live event streams allows the event-driven trigger system to learn from past patterns and also adapt quickly to new trends.

At block 410, a determination is made that an external event is going to impact a service demand within the cluster. In an example, an external event may impact a service demand based on a determination that the external event will increase a network usage, cause one or more nodes to be offline, reduce network usage, or the like.

At block 412, a control signal is provided. In an example, the control signal may be provided by the event-driven trigger system to another component or device within the adaptive behavioral scaling node. In certain examples, the control signal may cause the other component or device to update an adjustment of resources among different nodes of the cluster.

At block 414, previous scaling events are analyzed. In an example, the previous scaling events may be the scaling performed on the nodes and pods within the cluster based on previous predicted workload demands. At block 416, the impact of the previous scaling events is determined. In certain examples, the impact of the previous scaling events may be any suitable impact, such as a positive impact or a negative impact. For example, the previous scaling events or resource reallocations may produce less latency between the nodes of the cluster, which in turn may result in a positive impact on the cluster. Alternatively, the previous scaling events or resource reallocations may produce greater latency between the nodes of the cluster or extreme utilization of processors, which in turn may result in a negative impact on the cluster.

At block 418, scaling policies within the cluster are adjusted. In certain examples, the adjustment of the scaling policies may include particular parameters, external events, node usage, or the like triggering resource scaling among the nodes. At block 420, workload demands within the cluster are predicted. In an example, the machine learning models within the adaptive behavioral scaling node may perform one or more operations to contribute to predicting workload changes in the nodes. Based on adaptive behavioral scaling node

At block 422, resources are dynamically adjusted between nodes of the cluster. In an example, the resources available to the different nodes of a cluster may include, but are not limited to, network bandwidth, access to shared CPU cores and shared memory. At block 424, resources are dynamically adjusted between pods of a node within the cluster, and the flow ends at block 426. In certain examples, the resources allocation adjusted between pods in a node may include, but are not limited to, CPU cores, memory, and storage. In an example, the reallocation or adjustment of resource between pods may enable better performance of applications assigned to different pods for execution.

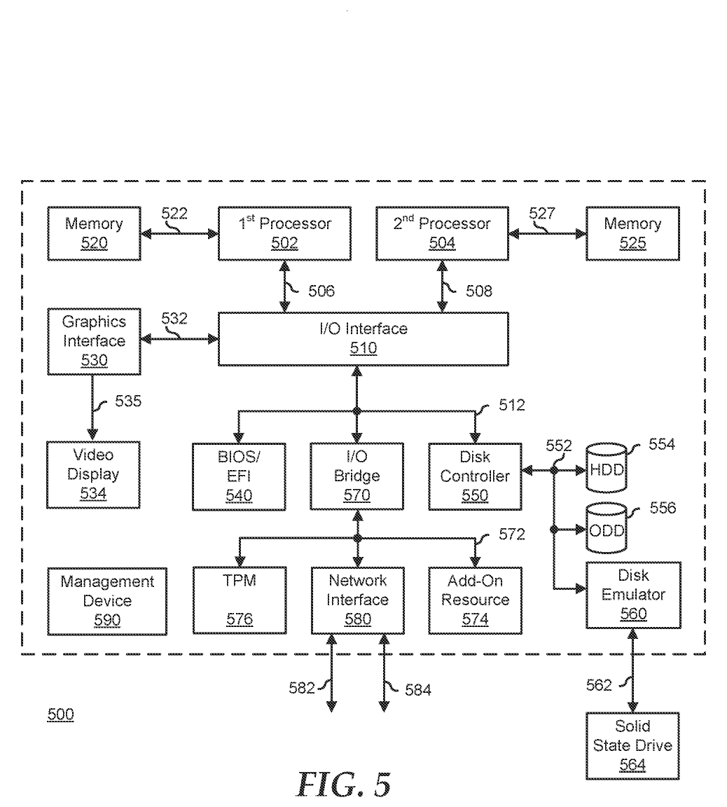

FIG. 5 shows a generalized embodiment of an information handling system 500 according to an embodiment of the present disclosure. Information handling system 500 may be substantially similar to each node 102, 104, 106, 108, and 110 of FIG. 1. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below and operates to perform one or more of the methods described below. Information handling system 500 includes a processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556 , a disk emulator 560 connected to an external solid state drive (SSD) 564, an I/O bridge 570, one or more add-on resources 574, a trusted platform module (TPM) 576, a network interface 580, a management device 590, and a power supply 595. Processors 502 and 504, I/O interface 510, memory 520, graphics interface 530, BIOS/UEFI module 540, disk controller 550, HDD 554, ODD 556, disk emulator 560, SSD 564, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532 and provides a video display output 536 to a video display 534. In a particular embodiment, information handling system 500 includes separate memories that are dedicated to each of processors 502 and 504 via separate memory interfaces. An example of memories 520 and 530 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 4394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512 or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, which operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (OOB) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500.

Management device 590 can operate off of a separate power plane from the components of the host environment so that the management device receives power to manage information handling system 500 when the information handling system is otherwise shut down. An example of management device 590 include a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed, or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

What is claimed is:

1. An adaptive behavioral scaling node of a cluster, the adaptive behavioral scaling node comprising:
a storage device configured to store a plurality of machine learning models, wherein the plurality of machine learning models include a first machine learning model and a second machine learning model; and
a processor to communicate with the storage device, the processor to:
execute the plurality of machine learning models;
based on the execution of the plurality of machine learning models, predict workload demands within the cluster, wherein the first machine learning model predicts a first portion of the workload demands based on historical data for the cluster and the second machine learning model predicts a second portion of the workload demands based on user behavior patterns; and
in response to the prediction of the workload demands, dynamically adjust resources among different nodes of the cluster.

2. The adaptive behavioral scaling node of claim 1, further comprising: an event component to communicate with the processor, the event component to:
monitor external events outside of the cluster for an impact on a service demand within the cluster; and
in response to a determination that one of the external events causing the impact on the service demand, provide a control signal to the processor.

3. The adaptive behavioral scaling node of claim 2, wherein in response to the control signal, the processor further to: update the adjustment of the resources among the different nodes of the cluster.

4. The adaptive behavioral scaling node of claim 1, wherein the processor further to:
analyze previous scaling events;
determine an impact of the previous scaling events on a performance of applications within the cluster; and
based on the impact of the previous scaling events, adjust scaling policies within the cluster.

5. The adaptive behavioral scaling node of claim 1, wherein in response to the prediction of the workload demands, the processor further to: dynamically adjust resources among different pods in a particular node of the cluster.

6. The adaptive behavioral scaling node of claim 1, wherein the processor further to: provide a scaling signal to an application programming interface (API) of a control node of the cluster, wherein the scaling signal causes the control node to perform an adjustment of the resources among the different nodes of the cluster.

7. The adaptive behavioral scaling node of claim 1, wherein the prediction of the workload demands within the cluster includes the processor further to:
determine real-time parameters in the cluster; and
utilize the real-time parameters in the prediction of the workload demands.

8. The adaptive behavioral scaling node of claim 7, wherein the real-time parameters includes a network input/output usage and disk usage in the different nodes on the cluster.

9. A method comprising:
storing, in a storage device of an adaptive behavioral scaling node of a cluster, a plurality of machine learning models, wherein the plurality of machine learning models include a first machine learning model and a second machine learning model;
executing, by a processor of the adaptive behavioral scaling node, the plurality of machine learning models stored in the storage device;
based on the execution of the plurality of machine learning models, predicting, by the processor, workload demands within the cluster, wherein the first machine learning model predicts a first portion of the workload demands based on historical data for the cluster and the second machine learning model predicts a second portion of the workload demands based on user behavior patterns; and
in response to the prediction of the workload demands, dynamically adjusting resources among different nodes of the cluster.

10. The method of claim 9, further comprising:
monitoring, by an event component, external events outside of the cluster for an impact on a service demand within the cluster; and
in response to a determination that one of the external events causing the impact on the service demand, providing, by the event component, a scaling signal to the processor.

11. The method of claim 10, wherein in response to the scaling signal, the method further comprising: updating the adjusting of the resources among the different nodes of the cluster.

12. The method of claim 9, further comprising:
analyzing previous scaling events;
determining an impact of the previous scaling events on a performance of applications within the cluster; and
based on the impact of the previous scaling events, adjusting scaling policies within the cluster.

13. The method of claim 9, wherein in response to the prediction of the workload demands, the method further comprises: dynamically adjust resources among different pods in a particular node of the cluster.

14. The method of claim 9, further comprising: providing a scaling signal to an application programming interface (API) of a control node of the cluster, wherein the scaling signal causes the control node to perform an adjustment of the resources among the different nodes of the cluster.

15. The method of claim 9, wherein the prediction of the workload demands within the cluster includes the method further comprising:
determining real-time parameters in the cluster; and
utilizing the real-time parameters in the prediction of the workload demands.

16. The method of claim 15, wherein the real-time parameters includes a network input/output usage and disk usage in the different nodes on the cluster.

17. A multiple node cluster environment comprising:
a first node including a first plurality of pods;
a second node including a second plurality of pods;
an adaptive behavioral scaling node to communicate with the first node and with the second node, the adaptive behavioral scaling node includes:
a storage device configured to store a plurality of machine learning models, wherein the plurality of machine learning models include a first machine learning model and a second machine learning model; and
a first processor to communicate with the storage device, the first processor to:
execute the plurality of machine learning models;
based on the execution of the plurality of machine learning models, predict workload demands within the cluster, wherein the first machine learning model predicts a first portion of the workload demands based on historical data for the cluster and the second machine learning model predicts a second portion of the workload demands based on user behavior patterns; and
in response to the prediction of the workload demands, provide a scaling signal; and
a control node to communicate with the first node, with the second node, and with the adaptive behavioral scaling node, the control node includes:
an application programming interface (API) to receive the scaling signal from the adaptive behavioral scaling node; and
a second processor to communicate with the API, the second processor to:
receiving the scaling signal from the API; and
based on the scaling signal, dynamically adjust resources among the first node and the second node.

18. The multiple node cluster environment of claim 17, wherein in response to the prediction of the workload demands, the second processor further to: dynamically adjust resources among different pods of the first plurality of pods.

19. The multiple node cluster environment of claim 17, wherein the first processor further to:
analyze previous scaling events;
determine an impact of the previous scaling events on a performance of applications within the cluster; and
based on the impact of the previous scaling events, adjust scaling policies within the cluster.

20. The multiple node cluster environment of claim 17, wherein in response to the prediction of the workload demands, the second processor further to: dynamically adjust resources among different pods of the second plurality of pods.
